(19) United States
(12) Patent Application Publication
(10) Pub. No.: US 2015/0326265 A1
(43) Pub. Date: Nov. 12, 2015

(54) MOBILE POWER DEVICE WITH INTEGRATED PROTECTIVE, CHARGING AND VOLTAGE-CONVERTING FUNCTIONS

(71) Applicant: CHUNG KAI YANG, NEW TAIPEI CITY (TW)

(72) Inventor: CHUNG KAI YANG, NEW TAIPEI CITY (TW)

(21) Appl. No.: 14/328,461

(22) Filed: Jul. 10, 2014

(30) Foreign Application Priority Data
May 12, 2014 (TW) 103208235

(51) Int. Cl. H04B 1/3883

(52) U.S. Cl. CPC H04B 1/3883

(57) ABSTRACT

A mobile power device with integrated protective, charging and voltage-converting functions includes a power conversion body, a power source body and an assembled frame. The power conversion body has an AC/DC converting unit. The power source body is connected to a supply sidewall of the power conversion body, having a charge element coupled to the AC/DC converting unit and a control module coupled to the charge element. The assembled frame is connected to a front surface of the power source body, configured for installing with a mobile device and applying electrical energy to the mobile device from an AC/DC or DC/DC converter. Specifically, a charge side wall of the power conversion body can be coupled to a commercial power outlet, thereby allowing for wireless charging of the mobile device.

### BACKGROUND OF THE INVENTION

1. Field of the Invention

The instant disclosure relates generally to a portable battery charger; in particular, to a mobile power device with integrated protective, charging and voltage-converting functions.

2. Description of Related Art

With the continuous improvement of technology, various types of mobile terminal products such as cell phones and tablet computers constantly weed out the old and bring forth the new. Nowadays, almost everyone has a favorite mobile terminal product. In order to carry mobile terminal products everywhere easily, the current trend is towards miniaturization and high performance. As far as mobile power is concerned, the miniaturized product must be limited in its electricity capacity.

Conventional mobile power devices generally include a main body and a secondary battery and a control circuit board arranged in the main body. When charging a cell phone or tablet computer battery, the mobile power device can provide appreciable electricity stored in a secondary battery at first and then converted by the control circuit board to the on board battery via a USB interface.

However, there is a need for said mobile power device to charge the battery by an additional USB cable. In addition, said mobile power device must be charged by supply mains via a voltage converter. That is to say, users need to carry said mobile power device with at least one USB cable and at least one voltage converter at the same time.

To address the above issues, the inventor strives via industrial experience and academic research to present the instant disclosure, which can effectively improve the limitations described above.

### SUMMARY OF THE INVENTION

The object of the instant disclosure is to provide a mobile power device with integrated protective, charging and voltage-converting functions. The mobile power device configured to install with a mobile device as an integral configuration can be carried everywhere easily. Moreover, the mobile power device can protect the mobile device from physical impacts.

In order to achieve the aforementioned objects, according to an embodiment of the instant disclosure, a mobile power device is configured for installing with a mobile device, and applying electrical energy to the mobile device from an AC/DC or DC/DC converter. The mobile power device includes a power conversion body, a power source body and an assembled frame. The power conversion body with an AC/DC converting unit has a main charge sidewall and a supply sidewall. The main charge sidewall has an electrical terminal set arranged thereon and coupled to the AC/DC converting unit. The supply sidewall has a power output interface arranged thereon and coupled to the AC/DC converting unit. The power source body is connected to the supply sidewall near the power output interface of the power conversion body. The power source body has a charge element coupled to the AC/DC converting unit and a control module coupled to the charge element. The assembled frame is connected to a front surface of the power source body.

Based on the above, in contrast with the conventional mobile power device, the instant mobile power device can install with the mobile device such as a smartphone as an integral configuration and charge the mobile device directly without cables. In addition, when the battery of the mobile device is running out of power, the power conversion body can work to generate electricity from commercial power to charge the battery by plugging its electrical terminals set into an electrical output. There is no need for users to carry voltage source converters and power cables, thereby increasing the practicability of charging their mobile device.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded view of a mobile power device according to a first embodiment of the instant disclosure;

FIG. 2 shows another exploded view of a mobile power device according to a first embodiment of the instant disclosure;

FIG. 3 shows an assembled view of a mobile power device according to a first embodiment of the instant disclosure;

FIG. 4 shows another assembled view of a mobile power device according to a first embodiment of the instant disclosure;

FIG. 5 is a block diagram showing a control system of a mobile power device according to a first embodiment of the instant disclosure;

FIG. 6 shows an exploded view of a mobile power device according to a second embodiment of the instant disclosure;

FIG. 7 shows another exploded view of a mobile power device according to a second embodiment of the instant disclosure;

FIG. 8 shows an assembled view of a mobile power device according to a second embodiment of the instant disclosure; and

FIG. 9 shows another assembled view of a mobile power device according to a second embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

The instant disclosure relates to a creative structural mobile power device. The mobile power device can install with a mobile device in an integral configuration for easy carry, and to provide good protection for the mobile device. Most importantly, the mobile power device can provide a stable electricity supply for long hours and will not overheat. Therefore, users can make phone calls, access internet, or play games without any possible worries about electricity deficiency.

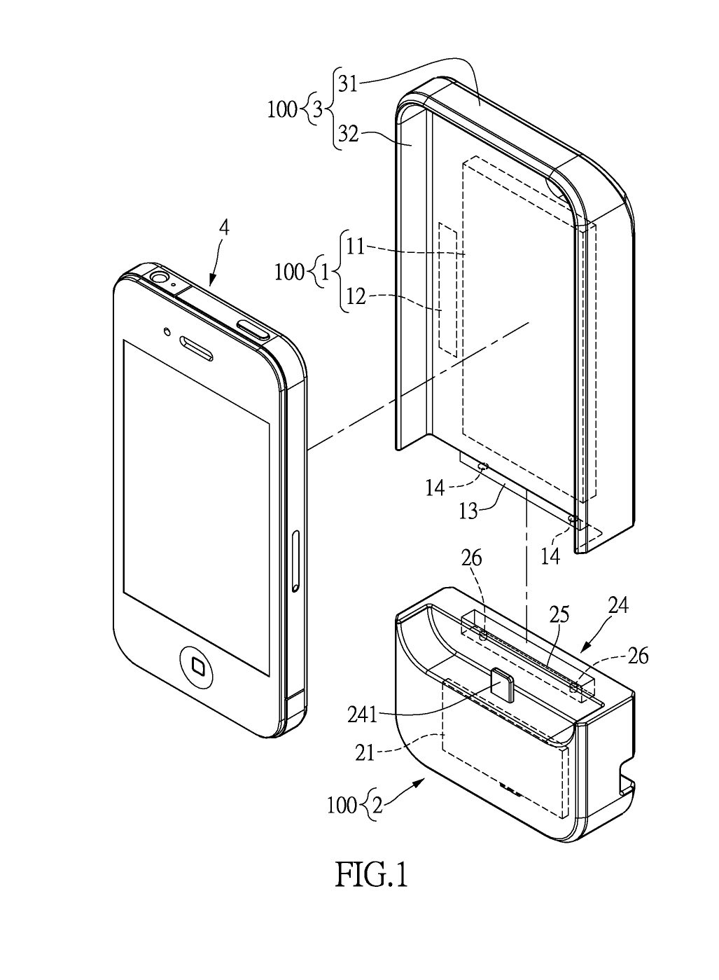

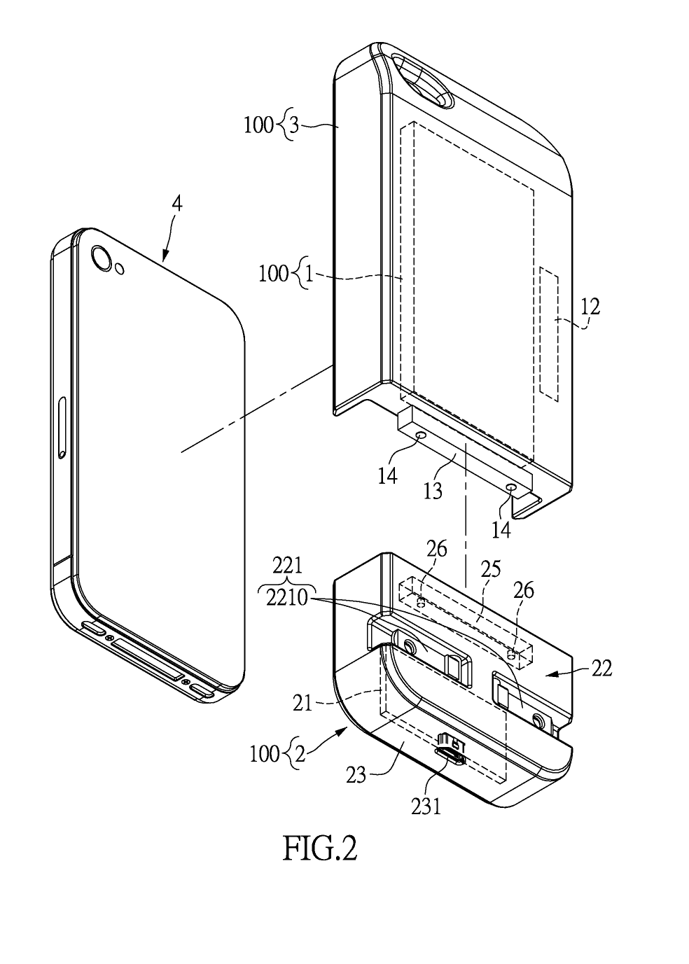

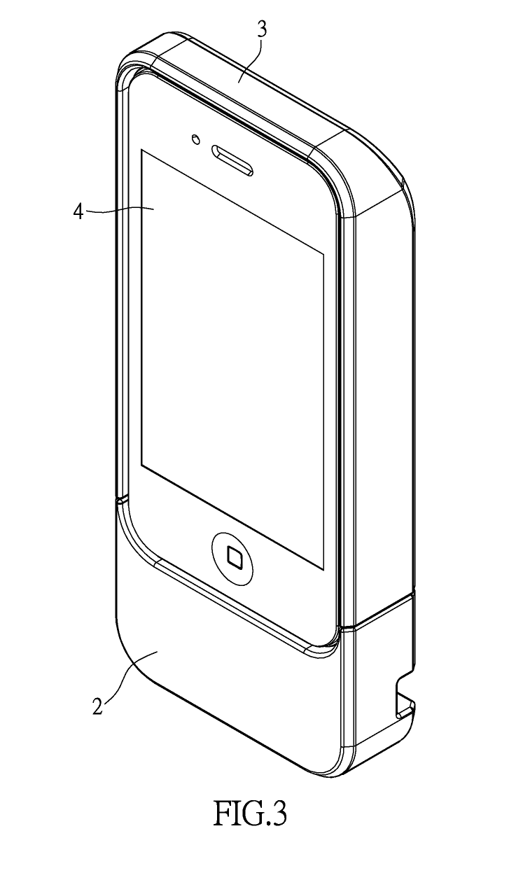

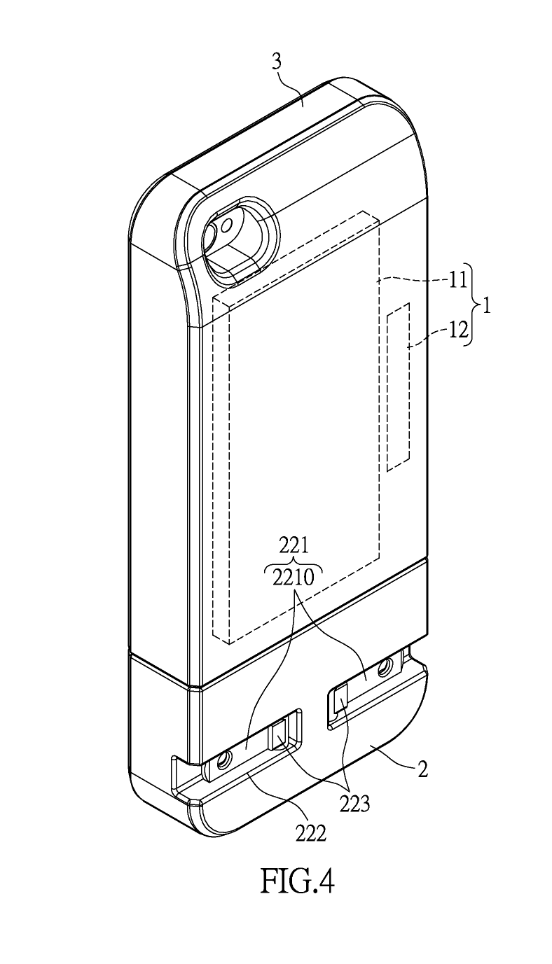

Please refer to FIGS. 1 and 2, each of which shows an exploded view of the mobile power device according the first embodiment of the instant disclosure. Please refer to FIGS. 3 and 4 as well, each of which shows an assembled view of the mobile power device according the first embodiment of the instant disclosure. As shown in figures above, for charging a mobile device 4, the mobile power device 100 is designed to integrate with the mobile device 4 to allow electricity supply to the mobile device 4 from an AC/DC or DC/DC converter.

The following will use a smartphone as an example to describe the features and advantages of the mobile power device 100. However, the person of ordinary skill in the art can modify the mobile power device 100 to install with any other suitable mobile devices within the spirit and scope of the instant disclosure.

The mobile power device 100 comprises a power source body 1, a power conversion body 2 and an assembled frame 3. The power source body 1 is designed with a charging area and a periphery area (not shown). There is a charge element 11 arranged in the charging area. There is a first control module 12, wires and elements arranged in the periphery area for electricity connection with the power conversion body 2.

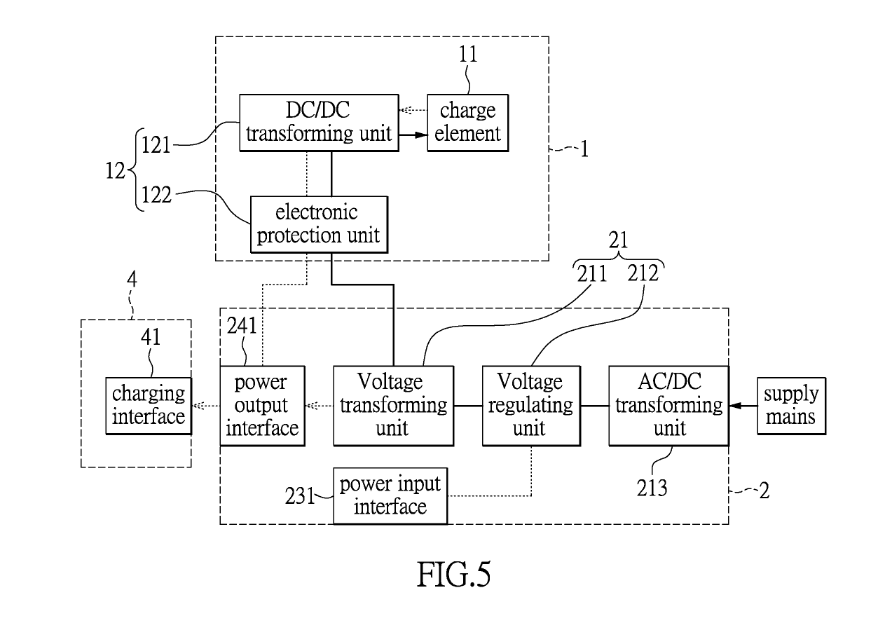

With reference to FIG. 5, the first control module 12 comprises a DC/DC converting unit 121 and electronic protection unit 122. The DC/DC converting unit 121 is adapted in response to mobile devices 4 with different input voltages. The protection unit 122 is adapted to prevent uncertain risks from the charge element 11, and provide functions such as overcurrent protection, overvoltage protection, load protection and short circuit protection. In practice, the charge element 11 can be a secondary battery such as, but not limited to, a lithium battery or nickel hydrogen battery.

The power conversion body 2 is designed with a voltage converting area (not shown). There is a second control module 21 arranged in the voltage converting area. Specifically, the second control module 21 comprises a voltage converting unit 211, a voltage regulating unit 212 and an AC/DC converting unit 213. The AC/DC converting unit 213 is adapted to convert AC voltage from current supply mains to DC. The voltage regulating unit 212 is adapted to stabilize the DC voltage converted by the AC/DC converting unit 213. The voltage converting unit 211 is adapted to convert the input voltage from the voltage regulating unit 212, and then provide an output voltage to the power source body 1 to charge the charge element 11. In practice, the output voltage from the voltage converting unit 211 can be 5V or 4.2V DC voltage that satisfies the power requirement of the charge element 11 and the mobile device 4.

It is worth noting that the charge element 11 and the AC/DC converting unit 213 are completely separated. Specifically, the charge element 11 and the AC/DC converting unit 213 are integrated to be arranged in the power source body 1 and the power conversion body 2 respectively. Moreover, the mobile power device 100 has an installation mechanism that is configured to fasten to the mobile device 4. Accordingly, the mobile power device 100 can prevent the charge element 11 from overheating via an effective heat dissipation of the installation mechanism.

Referring to FIGS. 1-2 and 4-5 again, the power conversion body 2 is designed with a main charge side wall 22, secondary charge side wall 23 and a supply side wall 24. In this way, both reliable combination and high electrical conductivity between the power source body 1, the power conversion body 2 and the mobile device 4 can be achieved. Specifically, the main charge side wall 22 has an electrical terminal set 221 arranged thereon for electricity connection with the current supply mains. Preferably, there are two terminal slots 222 concavely arranged on the main charge side wall 22 and spaced an interval apart. The electrical terminal set 221 has two electrical terminals 2210, each of which is pivotally arranged in the corresponding terminal slot 222 by a pivoting structure 223. Accordingly, the electrical terminals 2210 can be pivoted to project outwardly from the terminal slots 222 for plugging into the wall outlet, or contained in the terminal slots 222 when they are not in use.

The secondary charge side wall 23 has a power input interface 231 arranged thereon. The power input interface 231 has the function of voltage conversion and can be configured to connect to the same transmission interface of a power supply (not shown). The supply side wall 24 has a power output interface 241 arranged thereon for electricity connection with a charging interface 41 of the mobile device 4. In practice, the power input interface 231 of the secondary charge side wall 23 and the power output interface 241 of the supply side wall 24 can be, but is not limited to, micro USB interfaces. Accordingly, various methods can be used to charge the mobile power device 100. For example, the mobile power device 100 can supply electrical energy to the mobile device 4 through a transmission cable.

The bottom end of the power source body 1 has an engagement portion 13 arranged thereon and a plurality of electrical contact pads 14 such as anode and cathode pads within the engagement portion 13. The supply sidewall 24 of the power conversion body 2 has a position-limiting portion 25 arranged near the power output interface 241 in correspondence with the engagement portion 13 of the power source body 1 and a plurality of electrical contact pins 26 such as anode and cathode pins within the position-limiting portion 25. The electrical contact pads 14 are electrically connected to the charge element 11, and the electrical contact pins 26 are electrically connected to the voltage converting unit 211. Accordingly, the electricity connection between the power source body 1 and the power conversion body 2 can be completed by engaging the engagement portion 13 with the position-limiting portion 25 to allow the electrical contact pads 14 to contact the electrical contact pins 26.

In practice, the electrical contact pins 26 of the power conversion body 2 can be resilient pins which shrink inwardly back into the supply sidewall 24 when touching the electrical contact pads 14 of the power source body 1. The engagement portion 13 of the power source body 1 can be an annular rib, and the position-limiting portion 25 of the power conversion body 2 can be a position-limiting slot. However, the instant disclosure is not limited thereto.

The assembled frame 3 integrally extends from the surface of the power source body 1 and is designed to fit the mobile device 4. The assembled frame 3 comprises a first assembled wall 31 and two second assembled walls 32 extending away from the two opposing sides of the first assembled wall 31 respectively. The first and second assembled walls 31, 32 create an installation space (not shown) which is configured to hold the mobile device 4. Thus, the mobile power device 100 can provide a reliable, stable electricity supply to charge the mobile device 4 for long hours and will not overheat.

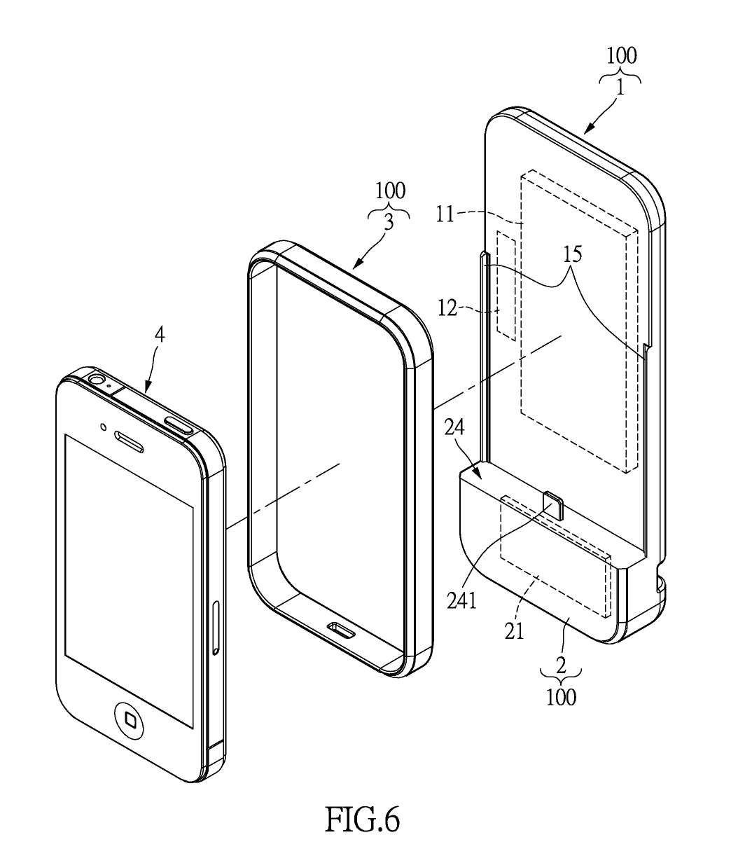

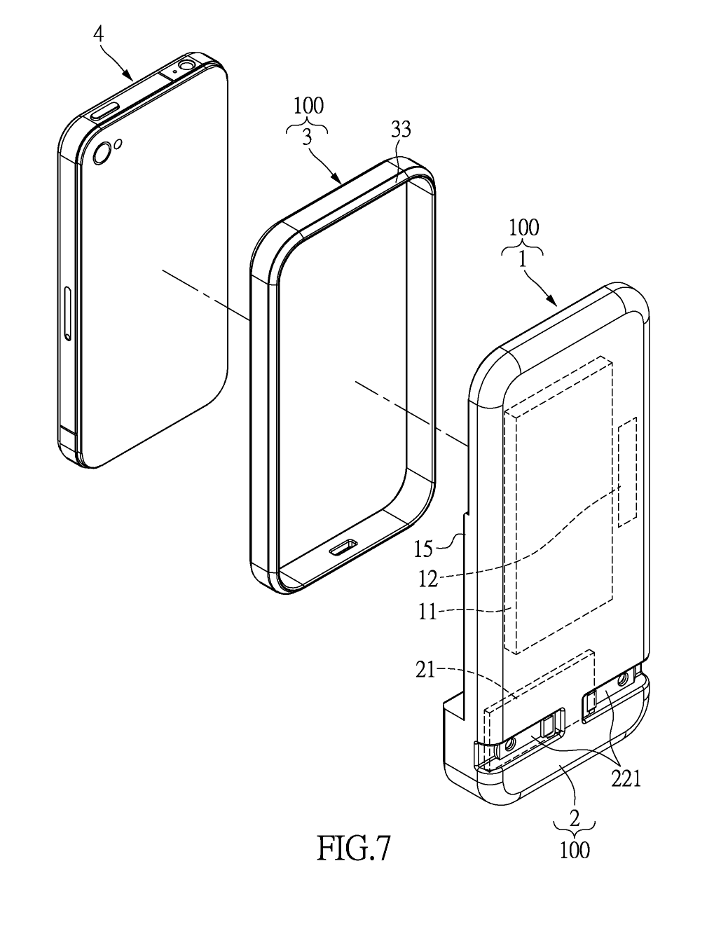

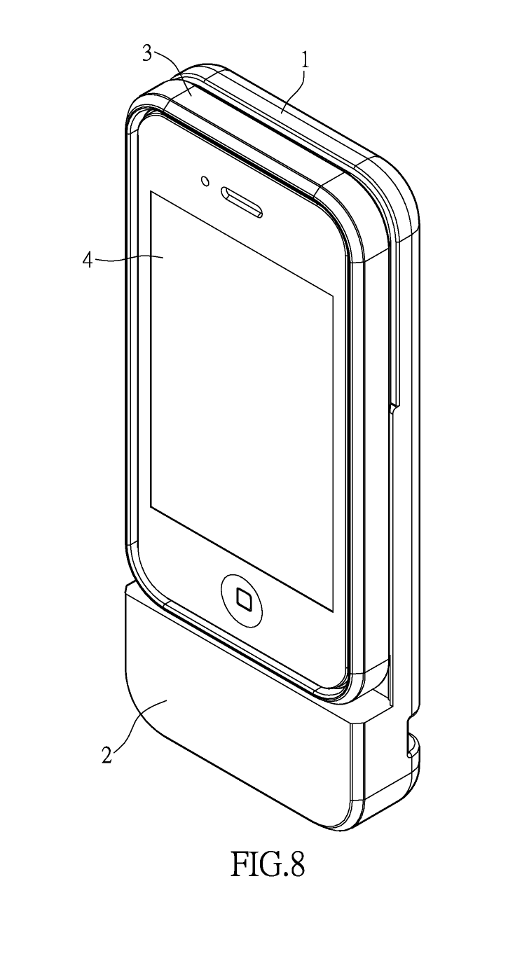

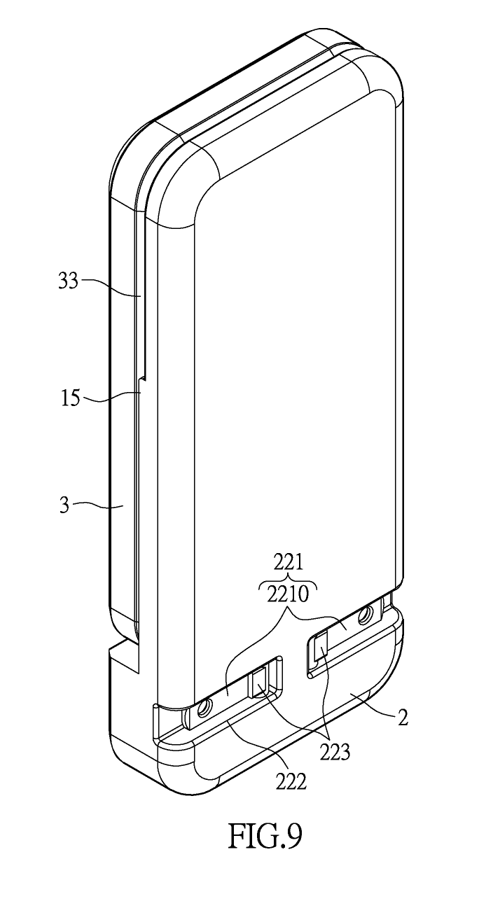

Please refer to FIGS. 6 and 7, each of which shows an exploded view of the mobile power device according the second embodiment of the present invention. Please refer to FIGS. 8 and 9 as well, each of which shows an assembled view of the mobile power device according the second embodiment of the present invention. The instant embodiment has improved from the preceding embodiment through the modification of the power source body 1, the power conversion body 2 and the assembled frame 3. The power source body 1 is integrally formed with the power conversion body 2, and the assembled frame 3 is configured to engage with the power source body 1.

Specifically, the power source body 1 extends vertically from the supply sidewall 24 of the power conversion body 2. The power source body 1 has two opposing linear guide rails 25 that project axially in a direction perpendicular to the surface thereof. The length of each of the two linear guide rails 25 is less than or equal to the length of the power source body 1. The upper end of each of the two linear guide rails 25 is bent inwardly a little.

The assembled frame 3 is designed to include a gradually shrinking portion 33. The gradually shrinking portion 33 is configured to slidably engage the two opposing linear guide rails 25 via a linear movement from a first position apart from the power source body 1 to a second position approaching the power source body 1, thereby installing the mobile device 4 with the power source body 1. Furthermore, the mobile power device 100 also provides a reliable, stable electricity supply to charge the mobile device 4 for long hours and will not overheat.

Based on the above, in comparison with the conventional mobile powers, the instant mobile power device can install with a mobile device such as smartphone in an integral configuration to charge the mobile device directly without a transmission line. In addition, when the mobile device runs out of power, the power conversion body can work to generate appreciable electricity from supply mains to charge the mobile device. There is no need for users to carry voltage source converters and power cables, thereby increasing the usability.

Further, the charge element and the AC/DC converting unit are designed to be completely separated. Thus, the instant mobile power device can provide a reliable, stable electricity supply to charge the mobile device for long hours and will not overheat. That is, the users can make phone calls, access internet, or play games without any possible worries about electricity deficiency.

Furthermore, due to the assembled frame surrounding the periphery of the mobile device. The instant mobile power device can prevent the mobile device from physical impacts.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A mobile power device with integrated protective, charging and voltage-converting functions, configured for installing with a mobile device, and applying electrical energy to the mobile device from an AC/DC or DC/DC converter, comprising:
a power conversion body with an AC/DC converting unit, having a main charge sidewall and a supply sidewall, the main charge sidewall has an electrical terminal set arranged thereon and coupled to the AC/DC converting unit, and the supply sidewall has a power output interface arranged thereon and coupled to the AC/DC converting unit;
a power source body connected to the supply sidewall near the power output interface of the power conversion body, having a charge element coupled to the AC/DC converting unit and a control module coupled to the charge element;
an assembled frame connected to a front surface of the power source body.

2. The mobile power device according to claim 1, wherein the supply sidewall of the power conversion body has a position-limiting portion arranged near the power output interface, and the bottom end of the power source body has an engagement portion arranged thereon configured to engage with the position-limiting portion of the power conversion body.

3. The mobile power device according to claim 2, wherein the supply sidewall of the power conversion body has a plurality of electrical contact pins arranged within the position-limiting portion, and the bottom end of the power source body has a plurality of electrical contact pads within the engagement portion configured to contact the electrical contact pins.

4. The mobile power device according to claim 2, wherein the engagement portion is an annular rib, and the position-limiting portion is a position-limiting slot.

5. The mobile power device according to claim 3, wherein the assembled frame integrally extends from the surface of the power source body.

6. The mobile power device according to claim 5, wherein assembled frame comprises a first assembled wall and two second assembled walls extend away from the two opposing sides of the first assembled wall respectively, and the first and second assembled walls create an installation space for holding the mobile device.

7. The mobile power device according to claim 1, wherein the power source body extends vertically from supply sidewall of the power conversion body.

8. The mobile power device according to claim 7, wherein the power source body has two opposing linear guide rails that project axially in a direction perpendicular to the surface of the power source body, the length of each of the two linear guide rails is less than or equal to the length of the power source body, and the assembled frame has a gradually shrinking portion that integrally extends from the bottom end thereof.

9. The mobile power device according to claim 1, wherein the electrical terminal set comprises two electrical terminals.

10. The mobile power device according to claim 9, wherein the main charge sidewall has two terminal slots concavely arranged thereon and spaced an interval apart, and the two electrical terminals are pivotally arranged in the two terminal slots respectively.
